(19) United States
(12) Patent Application Publication
(10) Pub. No.: US 2009/0211720 A1
(43) Pub. Date: Aug. 27, 2009

(54) Composite Materials, Method for Their Preparation, and Use in Paper and Board Manufacturing

(76) Inventors: Vesa Myllymäki, Helsinki (FI); Reijo Aksela, Espoo (FI); Anna Sundquist, Helsinki (FI); Saila Karvinen, Pori (FI)

Correspondence Address: CANTOR COLBURN, LLP, 20 Church Street, 22nd Floor, Hartford, CT, 06103, US

(21) Appl. No.: 11/886,648

(22) PCT Filed: Mar. 15, 2006
(86) PCT No.: PCT/FI2006/000088

§ 371 Date: Mar. 13, 2009

(30) Foreign Application Priority Data
Mar. 18, 2005 (FI) 20050293

(51) Int. Cl. D21H 17/25; C09D 105/00; D21H 17/24

(52) U.S. Cl. 162/176; 106/217.9; 162/175

(57) ABSTRACT

The invention relates to a composite material based on water-insoluble polysaccharide. The composite material includes particles of at least one light scattering material, the surface of which is essentially covered by at least one water-insoluble polysaccharide material. The invention also relates to a method for the preparation of the composite material. Further, the invention relates to a paper and board manufacturing process, in which said composite materials are employed as manufacturing materials. Both highly organic end products with exceptional heat capacities and cheap, high filler end products can be manufactured. The invention also relates to a method for improving retention of light scattering filler material in the manufacture of paper and board.

### FIELD OF THE INVENTION

The present invention is directed to new composite materials, a method for their preparation and their use in paper and board manufacturing

### BACKGROUND ART

### Fillers and Pigments in Paper and Board Manufacturing

Substituting part of virgin fibers in paper and board manufacturing has been practiced since 8^{th} century (Beazley, K. Papermaking fillers: A literature Review, Pira). Recently, it is an integral part of the paper and board making technology. Up to date, mineral fillers and pigments are the dominant component of the pulp furnishes, but there are also emerging examples of fillers and pigments of organic nature. One such organic light scattering material is urea formaldehyde. These are used to reduce manufacturing costs but also to provide end products with desired functionalities and end-use properties. Such functionalities and end-use properties are usually obtained by using light scattering material in paper or board. The economic importance is of paramount importance, an estimated $2.5/ton of end product is saved for each increase of filler in paper.

From an environmental point of view, supplementing virgin fibers is of course important. The paper and board production capacities are increased without the addition of pulping capacity. Further, it reduces operating costs, and improves paper properties such as opacity, gloss, porosity and brightness. Better printability properties are obtained as result of the improvement in surface smoothness, printing ink absorption becomes more uniform, and the gloss of the paper after calandering can be improved.

There are certain limits for filler and pigment contents in the paper and board end products. When reaching beyond the conventional levels, the paper strength is dramatically decreased, and thus, demand for additional chemicals such as sizing agents is increased. Further, the abrasion at paper and board production facilities is increased. Also a higher content of fine material in the circulation water system is anticipated. The dusting tendency during printing is increased. Many of said problems are associated with a poor retention of fillers and pigments in paper and board manufacturing processes. Many of the problems are related to the lower degree of fiber-fiber bonding. To reach the optimum optical properties, fillers and pigments must be applied in such content that the densities and thus, the weights of the paper and board product increase heavily.

Typically, large quantities of filler are used in fine papers and magazine paper grades, whereas inert light scattering material particles employed as fillers have begun to be used also in newsprint, wrapping paper etc. Special grades, such as laminate paper, bible paper, cigarette paper, etc. can contain up to 40% filler or pigment. In newsprints the levels typically vary between 0 and 10% (kaolin clay, talc, special pigments), in magazine papers (uncoated, SC) between 20 and 30% (caolin clay, talc); in fine paper between 0 and 25% (kaolin clay, talc, chalk, TiO₂), and in wrapping paper between 0 and 10% (kaolin clay, talc, chalk, TiO₂).

The desired properties for fillers and pigments are:

To be chemically inert and insoluble;

To have a high retention on the paper machine so that as little as possible is lost. The retention is dependent on retention aid, however, and is seldom optimized for filler;

To have 100% remission of light at all wavelengths to give maximum whiteness (light scattering materials);

To have a low density, to be soft, to be free from abrasives, colored compounds, metal ions, etc.;

To have a very high refractive index in order to give maximum opacity;

To have low price.

The optimal particle size would be 0.2-0.3 μm, about half of the average wavelength of light in order to give maximum opacifying properties. However, a typical particle size for fillers is 0.4-5 μm. This is due to increased production cost when preparing smaller particles.

The fillers and pigments are segmented to natural and synthetic light scattering materials. The first mentioned are cheaper, the latter typically having exceptional properties. Most commonly used light scattering materials are titanium dioxide, kaolin clay, calcinated clay, talc, gypsum, calcium carbonate, hydrated aluminum oxide, sodium alumino silicate, calcium alumino silicate, barium sulfate, hydrated aluminum potassium silicate, diatomaceous earth, calcium oxalate and zinc oxide.

### Composites Based on Water-Insoluble Polysaccharides

Polymer Science dictionary (Alger, M. S. M, Elsewier Applied Sciense, 1990, p. 81) describes composite material as following: “A solid material which consists of a combination of two or more simple (or monolithic) materials and in which the individual components retain their separate identities. A composite material has properties different from those of its component simple materials; use of term composite often implies that the physical properties are improved since the main interest technologically is in obtaining materials with superior properties to those of composite's component materials. A composite material also has a heterogeneous structure containing two or more phases arising from its components. The phases may be continuous phases or more one or more may be dispersed phases within a continuous matrix.”

WO2004084627 describes a method for encapsulating active substances into cellulose matrix. The active substances have typically organic, molecular nature and are not distributed to cellulose matrix as particles. Rather, they are dissolved into ionic liquid cellulose-solution. Therefore, they are not called composite materials but regenerated cellulose-encapsulated active substances.

The only employed material in particle form was magnetite. The obtained product was a black film, active magnetite particles being distributed in it. Drying of the product yielded a hard, black solid. The same paper teaches that this active material could be employed in membrane/extractant processing.

JP2298516 (Kanebo Ltd.) describes organic pigment containing cellulose particles and their manufacture. The prepared particles have dark color and are to be used as colorants. The color originates from organic pigments, which are dissolved into viscose with a polyethylene glycol derivative having metal ions capable of forming salts with the organic pigment. Thus, the organic pigments are chemically modified during the process and do not retain their own identity in the product. In a second Kanebo patent (JP3028241), chitosan is dissolved into viscose solution to give product, in which active chitosan can be applied as a support for immobilizing an enzyme. The product is also used as an active packing for liquid chromatography. A water-soluble anionic polymeric compound is required as a component in order to prepare the composite material. Chitosan is water soluble and does not exhibit light scattering properties. Additionally, it is of organic nature.

WO0250169 describes a method for compounding polymer with filler. The employed polymer is polyethylene, i.e., a synthetic polymer not capable of hydrogen bonding like polysaccharides. The material is prepared by grinding the materials together in the solid state, when the reactive or adhesive moieties are released from inside talc, which react with reactive and adhesive moieties formed of the polyethylene in the same grinding. Thus, the materials are subjected to reactions, the individual starting components not retaining their separate identities.

### Ionic Liquids

The literature knows many synonyms of ionic liquids. Up to date, “molten salts” is maybe the most broadly applied term to describe ionic compounds in the liquid state (typically at temperatures from −100° C. to 200° C., even at 300° C.). There is a difference between molten salts and ionic liquids, however. Ionic liquids are salts that are liquid around room temperature (Wassercheid, P.; Welton, T., Ionic Liquids in Synthesis 2003, WILEY-VCH, p. 1-6, 41-55 and 68-81). Therefore, the term RTIL (room temperature ionic liquids) is commonly applied for these solvents.

RTILs are non-flammable and non-volatile, and they possess high thermal stabilities. Typically, these solvents are organic salts or mixtures consisting of at least one organic component. By changing the nature of the ions present in an RTIL, it is possible to change the resulting properties of the RTIL. The lipophilicity of a RTIL is easily modified by the degree of cation substitution. Similarly, the miscibility with water and other protic solvents can be tuned from complete miscibility to almost total immiscibility, by changing the anion substitution.

All these variations in cations and anions can produce a very large range of ionic liquids allowing the fine-tuning of RTIL's for specific applications. It has been estimated that approximately 70 million different ionic liquids could be prepared. Furthermore, the RTIL's are easy to manufacture. They can also be reused after regeneration.

### Ionic Liquids in Dissolution of Polysaccharides

Cellulose has been dissolved into a variety of different solvents. U.S. Pat. No. 1,943,176 discloses a process for the preparation of solutions of cellulose by dissolving cellulose under heating in a liquefied N-alkylpyridinium or N-benzylpyridinium chloride salt, preferably in the presence of an anhydrous nitrogen-containing base, such as pyridine. These salts are known as ionic liquids as described earlier. The cellulose to be dissolved is preferably in the form of regenerated cellulose or bleached cellulose or linter. The employed ionic liquid is BMIMCl. U.S. Pat. No. 1,943,176 also suggests separating cellulose from the cellulose solution by means of suitable precipitating agents, such as water or alcohol to produce for example cellulose threads or films or masses. WO 03/029329 discloses a dissolution method very similar to the one disclosed in U.S. Pat. No. 1,943,176. The main improvement resides in the application of microwave radiation to assist in dissolution and employment of ionic liquids alone, i.e., no anhydrous nitrogen containing bases as auxiliary solvents are required. The cellulose dissolved is always in highly pure form. WO 03/029329 discloses a wide range of ionic liquids with different cationic and anionic counterparts in which cellulose can be dissolved. This article also teaches precipitating cellulose from the ionic liquid solution by the addition of water or other precipitating solutions including ethanol and acetone.

Zhang et al. (Homogeneous acetylation of cellulose in a new ionic liquid, Biomacromolecules 2004, 266-268) have been able to dissolve cellulose effectively in a BMIMCl related ionic liquid incorporating a double bond moiety into one of the side chains (AMIMCl). This modification accomplished rapid dissolution of cellulose (15 min) without any need for microwave assistance. Microwave techniques are described in, for example, D. Michael P. Mingos; “Microwaves in chemical synthesis” in Chemistry and industry 1, August 1994, pp. 596-599). Loupy et. al. have recently published a review concerning heterogenous catalysis under microwave irradiation (Loupy, A., Petit, A., Hamelin, J., Texier-Boullet, F., Jachault, P., Mathe, D.; “New solvent-free organic synthesis using focused microwave” in Synthesis 1998, pp. 1213-1234). Another representative article in the area of microwaves is published by Strauss as an invited review article (C. R. Strauss; “A combinatorial approach to the development of Environmentally Benign Organic Chemical Preparations”, Aust. J. Chem. 1999, 52, p. 83-96).

### SUMMARY OF THE INVENTION

The poor retention of inert light scattering material particles and problems related to a lower degree of bonding between the fibers when employing inert light scattering material particles in the manufacturing of paper and board especially as fillers but also as coating pigments is limiting their use to certain, rather low content levels. The present retention levels are achieved by aid of expensive retention chemicals.

When exceeding the light scattering material content beyond conventional levels, the strength of paper or board product is weakened and the dusting tendency during printing increases. A higher content of fine material in the circulation water system is also anticipated. The use of hard inert light scattering material particles as fillers and/or pigments also causes a faster wear of the wire and other parts of the paper machine as well as printing plates in the printing press.

Light scattering materials combine lower price of the end product with improved paper and board properties such as optical properties, porosity and printability. From the economic point of view, the possible maximum load of such particles into the paper or board product practically directs the amount of expensive fibers required in the paper and board manufacturing.

If their retention could be improved and the problems associated with declining degree of bonding between the fibers could be diminished, or more preferably completely avoided, this would accomplish several economic as well as environmental benefits.

Due to emerging environmental problems with waste paper and board, alternatives to inorganic light scattering materials are eagerly developed. They should be organic, water insoluble materials, which have high heat capacities being therefore convenient sources for energy production. Additionally, they should be light in order to diminish problems with high densities and weights associated with inorganic materials. The term “energy paper” has been introduced for such products.

It is an object of this invention to provide new types of composite materials derived from water-insoluble polysaccharides and particles of one or several light scattering materials. These can have extremely high light scattering material particle contents or on the contrary, extremely low contents of the light scattering material.

Another object of this invention is to provide a process for preparing composite materials based on water-insoluble polysaccharides and particles of one or several light scattering material.

A further object of the present invention is to provide a process for manufacturing paper and board, in which said composite materials are employed as manufacturing materials. The paper or board product can be prepared partially or substantially completely of said composite material. When employed partially, the composite material is employed as filler. The employed composites can have extremely high light scattering material contents to decrease the prices of the end products while retaining the physical and retaining or improving the optical properties. The composite materials can also have extremely low contents of light scattering materials, enabling production of environmental and light paper and board end products with distinctively high heat capacities.

Still another object is to provide a method for improving retention of light scattering filler material employing one or several light scattering materials in the form of particles surrounded by a continuous phase of water-insoluble polysaccharide to form a filler material, which is employed in the paper/board machine in the manufacture of paper or board.

Further objects will become apparent from the following description and claims.

The above mentioned problems have now been solved by the surprising discovery that composite materials based on water-insoluble polysaccharides and various size of inert light scattering material particles can be prepared by varying the contents of both polysaccharide and light scattering particles by weight in a highly tunable, practically unlimited manner. In these composite materials, light scattering materials with retained particle sizes, and thus functions, are surrounded by a continuous or a substantially continuous phase of fibers. With cellulose and chitin is hereby meant different grades and types of said polysaccharide polymers, these being chemically cellulose or chitin.

Cellulose and chitin are polysaccharides, which unlike starch, are water-insoluble fibers thus retaining their structure and properties regardless of water, additional chemicals and high temperatures associated with their use in paper and board manufacturing. With starch, gelatinization and dissolution of this polymer takes place in temperatures common in paper and board manufacturing, making starch material transparent leading to drastically weakened optical properties. Unlike cellulose and chitin, starch is of non-fibrous nature being thus an easily biodegradable and edible polymer, which is a great asset for different micro-organisms and slime formation at paper and board machines.

When dissolving the particles of light scattering material into an ionic liquid solution of cellulose or chitin or their mixture, said particles were surprisingly not dissolved, just homogeneously dispersed to said solution. Unexpectedly, the viscosity of the ionic liquid solution of cellulose or chitin decreased dramatically when adding the inert light scattering material particles into solution. This allowed preparation of solutions, in which unexpectedly high contents of the light scattering material particle in the resulting dispersion could be achieved while still keeping the dispersion in a workable condition. Even with low contents of cellulose or chitin in relation to inert light scattering material particles, composite products still having a continuous or a substantially continuous phase of a water-insoluble polysaccharide surrounding the particles could be formed.

Perhaps most unexpected were the results, where only minor contents of light scattering material changed the nature of the resulting dispersion in a manner where the addition of the non-solvent into said dispersion gave composite materials substantially formed of cellulose but with greatly diminished densities. The above feature could be strengthened by simultaneous bubbling of gas (air, nitrogen, CO₂ etc) into dispersion before and at the time of precipitating composite product with an appropriate non-solvent.

The composite products are separated economically by precipitating them with an appropriate non-solvent for the product. By controlling the composite contents, especially the degree of light scattering material, the nature of the non-solvent and temperatures of both the non-solvent and ionic liquid solution, wherein the particles of the light scattering material are dispersed, the structural form of the composite product can varied to give monoliths, flocs, particles, microspheres, fibers as well as films, the light scattering particles being covered with water-insoluble cellulose and/or chitin in different morphological forms.

When trialing said composite materials in paper and board manufacturing processes, these composite materials could be employed in a wide manner for example as fillers and pigments. Surprisingly, the retention of said composite materials was exquisitely high and good results were obtained regardless of the nature or size of the composite particle. The enhanced retention is presumably a consequence of dramatically enhanced fiber-fiber bonding capacity when compared to employing traditional filler and pigment particles without having such continuous or a substantially continuous phase of cellulose and/or chitin fibers surrounding said particles. Consequently, excellent physical properties such as paper strength of paper and board end products were obtained. Simultaneously and unexpectedly, remarkably better optical properties were gained while using the composite material as compared to conventional method employing same weight content of inert light scattering material particles.

Thus, excellent optical properties (for example such as opacity, scattering coefficient as well as absorption coefficient) can be achieved using much less inert light scattering material particles compared to quantity (weight) of light scattering material required to achieve same level of results in conventional paper and board manufacturing processes.

The present invention accomplishes manufacturing of paper and board grades with lower grammage but with retained or enhanced optical properties and substantially retained tensile strength. As an example, it is now possible to manufacture 60 g/m copy paper with retained optical and technical properties as compared to traditional 80 g/m² copy paper, thus diminishing radically the need of expensive fibers and additional chemicals in the paper product. In addition to great economic benefits, the invention also has inevitable environmental effects.

It is now also possible to increase the light scattering material content far beyond the limits existing with prior art technology. These high-filler products can be manufactured with excellent optical properties and substantially retained tensile strengths, thus supplementing expensive cellulose material and chemical additives.

As mentioned above, the composite materials can also have extremely low contents of light scattering materials. Since the resulting composite material is water-insoluble thus substantially retaining its structure in the paper and board manufacturing processes, these can be applied as high heat capacity fillers to prepare earlier mentioned “high energy paper and board products”. Principally, whole paper or board product can be prepared of said composite material.

Further, it is now possible to employing inert light scattering material particles with exquisite properties in composite materials presently not adaptable to paper and board manufacturing. For example hard structured rutile form titanium dioxide pigment grades have much better optical properties than corresponding softer anatase form pigment grades, which is susceptible to yellowing in the course of time. The present invention now solves such problems.

### BRIEF DESCRIPTION OF THE DRAWINGS

In the enclosed drawings the SEM-pictures imaging prepared composite materials are represented as pairs of composites with same composition but where different non-solvent are employed in precipitation and washing step:

FIG. 1a represents the 9:1 cellulose-TiO₂ (coated rutile, commercial Kemira 660 TiO₂ pigment) composite material 1 precipitated and washed with water.

FIG. 1b represents the 9:1 cellulose-TiO₂ (coated rutile, commercial Kemira 660 TiO₂ pigment) composite material 10 precipitated and washed with ethanol.

FIG. 2a represents the 8:2 cellulose-TiO₂ (coated rutile, commercial Kemira 660 TiO₂ pigment) composite material 2 precipitated and washed with water.

FIG. 2b represents the 8:2 cellulose-TiO₂ (coated rutile, commercial Kemira 660 TiO₂ pigment) composite material 11 precipitated and washed with ethanol.

FIG. 3a represents the 7:3 cellulose-TiO₂ (coated rutile, commercial Kemira 660 TiO₂ pigment) composite material 3 precipitated and washed with water.

FIG. 3b represents the 7:3 cellulose-TiO₂ (coated rutile, commercial Kemira 660 TiO₂ pigment) composite material 12 precipitated and washed with ethanol.

FIG. 4a represents the 6:4 cellulose-TiO₂ (coated rutile, commercial Kemira 660 TiO₂ pigment) composite material 4 precipitated and washed with water.

FIG. 4b represents the 6:4 cellulose-TiO₂ (coated rutile, commercial Kemira 660 TiO₂ pigment) composite material 13 precipitated and washed with ethanol.

FIG. 5a represents the 5:5 cellulose-TiO₂ (coated rutile, commercial Kemira 660 TiO₂ pigment) composite material 5 precipitated and washed with water.

FIG. 5b represents the 5:5 cellulose-TiO₂ (coated rutile, commercial Kemira 660 TiO₂ pigment) composite material 14 precipitated and washed with ethanol.

FIG. 6a represents the 4:6 cellulose-TiO₂ (coated rutile, commercial Kemira 660 TiO₂ pigment) composite material 6 precipitated and washed with water.

FIG. 6b represents the 4:6 cellulose-TiO₂ (coated rutile, commercial Kemira 660 TiO₂ pigment) composite material 15 precipitated and washed with ethanol.

FIG. 7a represents the 3:7 cellulose-TiO₂ (coated rutile, commercial Kemira 660 TiO₂ pigment) composite material 7 precipitated and washed with water.

FIG. 7b represents the 3:7 cellulose-TiO₂ (coated rutile, commercial Kemira 660 TiO₂ pigment) composite material 16 precipitated and washed with ethanol.

FIG. 8a represents the 2:8 cellulose-TiO₂ (coated rutile, commercial Kemira 660 TiO₂ pigment) composite material 8 precipitated and washed with water.

FIG. 8b represents the 2:8 cellulose-TiO₂ (coated rutile, commercial Kemira 660 TiO₂ pigment) composite material 17 precipitated and washed with ethanol.

FIG. 9a represents the 1:9 cellulose-TiO₂ (coated rutile, commercial Kemira 660 TiO₂ pigment) composite material 9 precipitated and washed with water.

FIG. 9b represents the 1:9 cellulose-TiO₂ (coated rutile, commercial Kemira 660 TiO₂ pigment) composite material 18 precipitated and washed with ethanol.

FIG. 10a represents the 9:1 cellulose-TiO₂ (anatase, commercial Kemira TiO₂ pigment) composite material 19 precipitated and washed with water.

FIG. 10b represents the 9:1 cellulose-TiO₂ (anatase, commercial Kemira TiO₂ pigment) composite material 28 precipitated and washed with ethanol.

FIG. 11a represents the 8:2 cellulose-TiO₂ (anatase, commercial Kemira TiO₂ pigment) composite material 20 precipitated and washed with water.

FIG. 11b represents the 8:2 cellulose-TiO₂ (anatase, commercial Kemira TiO₂ pigment) composite material 29 precipitated and washed with ethanol.

FIG. 12a represents the 7:3 cellulose-TiO₂ (anatase, commercial Kemira TiO₂ pigment) composite material 21 precipitated and washed with water.

FIG. 12b represents the 7:3 cellulose-TiO₂ (anatase, commercial Kemira TiO₂ pigment) composite material 30 precipitated and washed with ethanol.

FIG. 13a represents the 6:4 cellulose-TiO₂ (anatase, commercial Kemira TiO₂ pigment) composite material 22 precipitated and washed with water.

FIG. 13b represents the 6:4 cellulose-TiO₂ (anatase, commercial Kemira TiO₂ pigment) composite material 31 precipitated and washed with ethanol.

FIG. 14a represents the 5:5 cellulose-TiO₂ (anatase, commercial Kemira TiO₂ pigment) composite material 23 precipitated and washed with water.

FIG. 14b represents the 5:5 cellulose-TiO₂ (anatase, commercial Kemira TiO₂ pigment) composite material 32 precipitated and washed with ethanol.

FIG. 15a represents the 4:6 cellulose-TiO₂ (anatase, commercial Kemira TiO₂ pigment) composite material 24 precipitated and washed with water.

FIG. 15b represents the 4:6 cellulose-TiO₂ (anatase, commercial Kemira TiO₂ pigment) composite material 33 precipitated and washed with ethanol.

FIG. 16a represents the 3:7 cellulose-TiO₂ (anatase, commercial Kemira TiO₂ pigment) composite material 25 precipitated and washed with water.

FIG. 16b represents the 3:7 cellulose-TiO₂ (anatase, commercial Kemira TiO₂ pigment) composite material 34 precipitated and washed with ethanol.

FIG. 17a represents the 2:8 cellulose-TiO₂ (anatase, commercial Kemira TiO₂ pigment) composite material 26 precipitated and washed with water.

FIG. 17b represents the 2:8 cellulose-TiO₂ (anatase, commercial Kemira TiO₂ pigment) composite material 35 precipitated and washed with ethanol.

FIG. 18a represents the 1:9 cellulose-TiO₂ (anatase, commercial Kemira TiO₂ pigment) composite material 27 precipitated and washed with water.

FIG. 18b represents the 1:9 cellulose-TiO₂ (anatase, commercial Kemira TiO₂ pigment) composite material 36 precipitated and washed with ethanol.

FIG. 19a represents the 9:1 cellulose-kaolin clay composite material 37 precipitated and washed with water.

FIG. 19b represents the 9:1 cellulose-kaolin clay composite material 46 precipitated and washed with ethanol.

FIG. 20a represents the 8:2 cellulose-kaolin clay composite material 38 precipitated and washed with water.

FIG. 20b represents the 8:2 cellulose-kaolin clay composite material 47 precipitated and washed with ethanol.

FIG. 21a represents the 7:3 cellulose-kaolin clay composite material 39 precipitated and washed with water.

FIG. 21b represents the 7:3 cellulose-kaolin clay composite material 48 precipitated and washed with ethanol.

FIG. 22a represents the 6:4 cellulose-kaolin clay composite material 40 precipitated and washed with water.

FIG. 22b represents the 6:4 cellulose-kaolin clay composite material 49 precipitated and washed with ethanol.

FIG. 23a represents the 5:5 cellulose-kaolin clay composite material 41 precipitated and washed with water.

FIG. 23b represents the 5:5 cellulose-kaolin clay composite material 50 precipitated and washed with ethanol.

FIG. 24a represents the 4:6 cellulose-kaolin clay composite material 42 precipitated and washed with water.

FIG. 24b represents the 4:6 cellulose-kaolin clay composite material 51 precipitated and washed with ethanol.

FIG. 25a represents the 3:7 cellulose-kaolin clay composite material 43 precipitated and washed with water.

FIG. 25b represents the 3:7 cellulose-kaolin clay composite material 52 precipitated and washed with ethanol.

FIG. 26a represents the 2:8 cellulose-kaolin clay composite material 44 precipitated and washed with water.

FIG. 26b represents the 2:8 cellulose-kaolin clay composite material 53 precipitated and washed with ethanol.

FIG. 27a represents the 1:9 cellulose-kaolin clay composite material 45 precipitated and washed with water.

FIG. 27b represents the 1:9 cellulose-kaolin clay composite material 54 precipitated and washed with ethanol.

FIG. 28a represents the 9:1 cellulose-calcium carbonate composite material 55 precipitated and washed with water.

FIG. 28b represents the 9:1 cellulose-calcium carbonate composite material 64 precipitated and washed with ethanol.

FIG. 29a represents the 8:2 cellulose-calcium carbonate composite material 56 precipitated and washed with water.

FIG. 29b represents the 8:2 cellulose-calcium carbonate composite material 65 precipitated and washed with ethanol.

FIG. 30a represents the 7:3 cellulose-calcium carbonate composite material 57 precipitated and washed with water.

FIG. 30b represents the 7:3 cellulose-calcium carbonate composite material 66 precipitated and washed with ethanol.

FIG. 31a represents the 6:4 cellulose-calcium carbonate composite material 58 precipitated and washed with water.

FIG. 31b represents the 6:4 cellulose-calcium carbonate composite material 67 precipitated and washed with ethanol.

FIG. 32a represents the 5:5 cellulose-calcium carbonate composite material 59 precipitated and washed with water.

FIG. 32b represents the 5:5 cellulose-calcium carbonate composite material 68 precipitated and washed with ethanol.

FIG. 33a represents the 4:6 cellulose-calcium carbonate composite material 60 precipitated and washed with water.

FIG. 33b represents the 4:6 cellulose-calcium carbonate composite material 69 precipitated and washed with ethanol.

FIG. 34a represents the 3:7 cellulose-calcium carbonate composite material 61 precipitated and washed with water.

FIG. 34b represents the 3:7 cellulose-calcium carbonate composite material 70 precipitated and washed with ethanol.

FIG. 35a represents the 2:8 cellulose-calcium carbonate composite material 62 precipitated and washed with water.

FIG. 35b represents the 2:8 cellulose-calcium carbonate composite material 71 precipitated and washed with ethanol.

FIG. 36a represents the 1:9 cellulose-calcium carbonate composite material 63 precipitated and washed with water.

FIG. 36b represents the 1:9 cellulose-calcium carbonate composite material 72 precipitated and washed with ethanol.

FIG. 37a represents TiO₂ (coated rutile, commercial Kemira 660 TiO₂ pigment) as such.

FIG. 37b represents represents microcrystalline cellulose fibers as such.

FIG. 38a represents TiO₂ (coated rutile, commercial Kemira 660 TiO₂ pigment) precipitated on cellulose in proportion of 1:1, in a traditional manner (example 73).

FIG. 38b represents a handsheet employing composite material KN04015/1 from example 75.

FIG. 39a represents a handsheet employing composite material KN04015/1 from example 75.

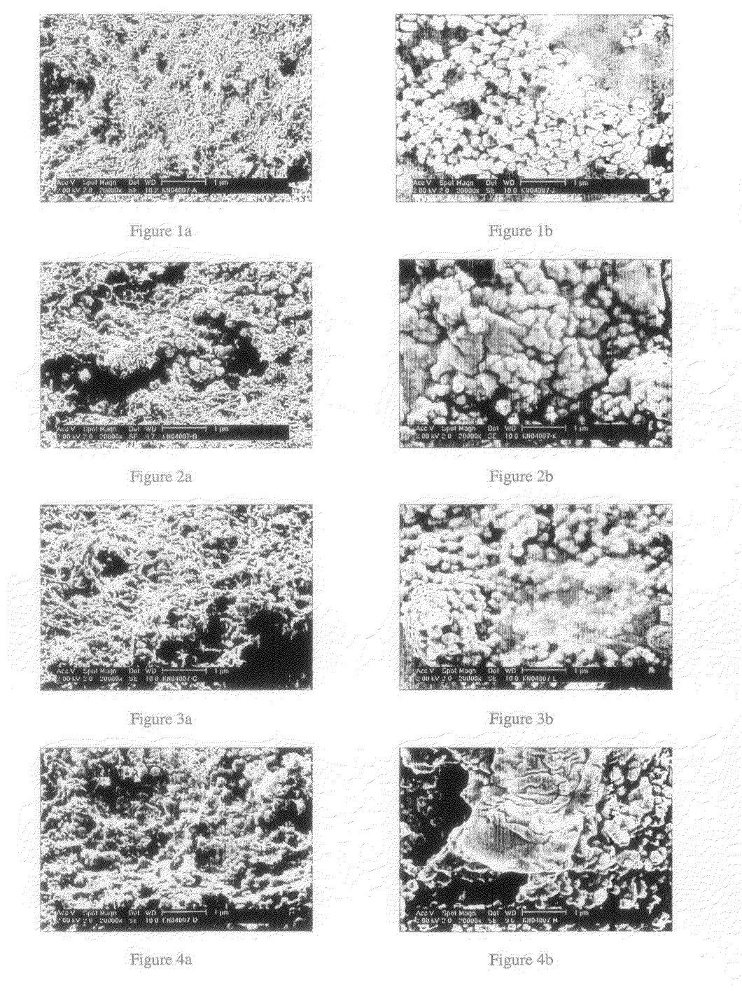

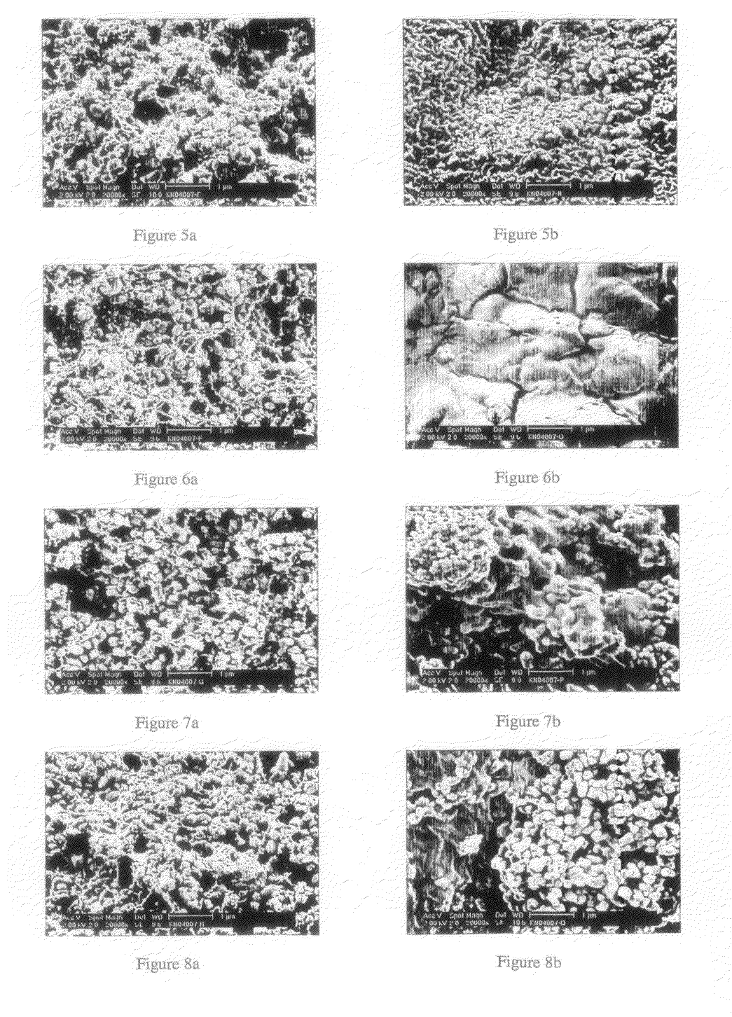

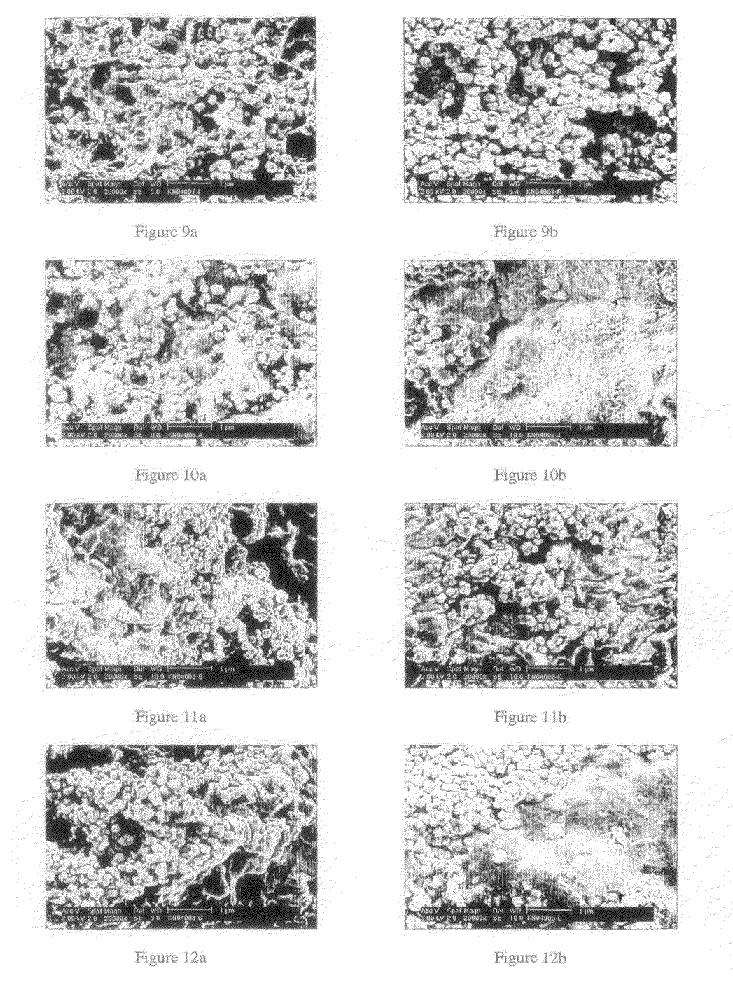

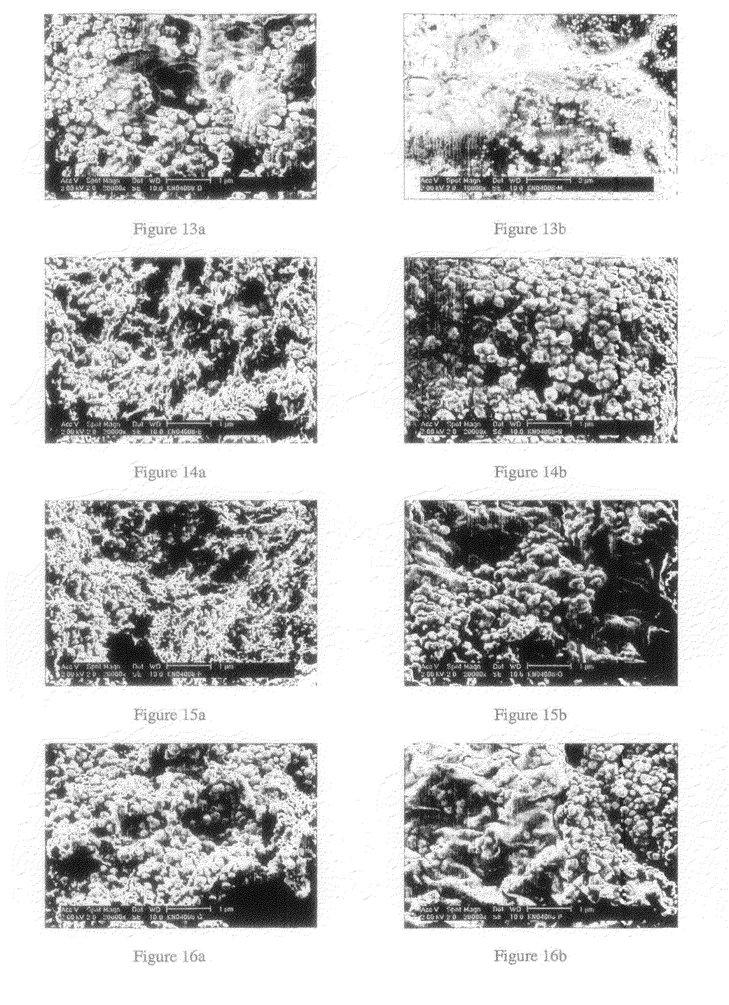

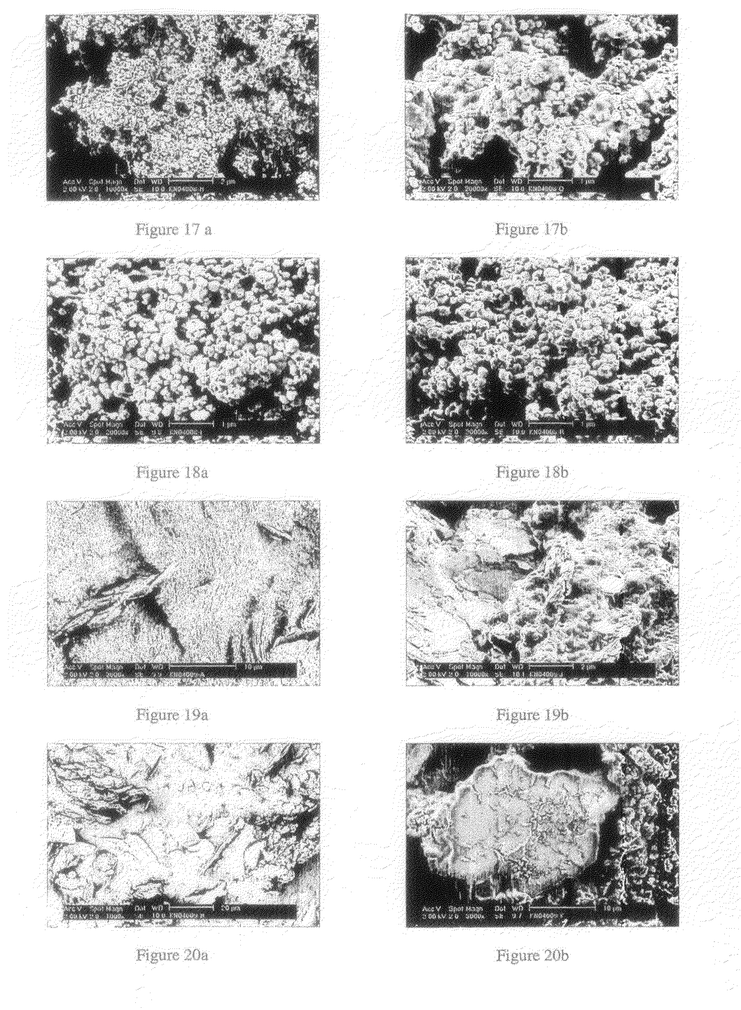

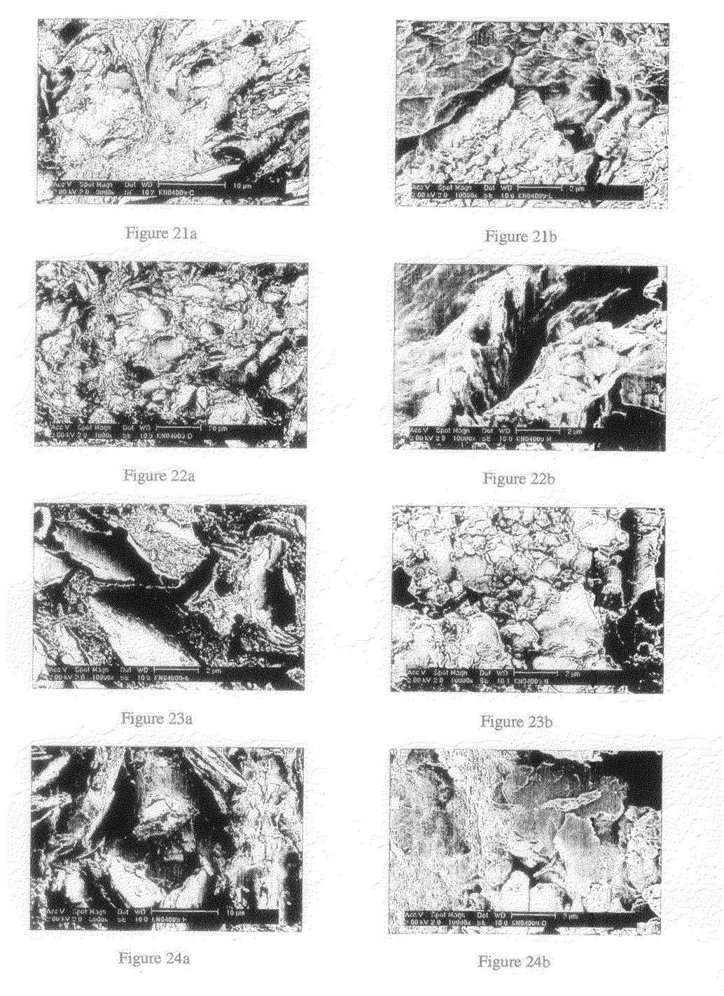

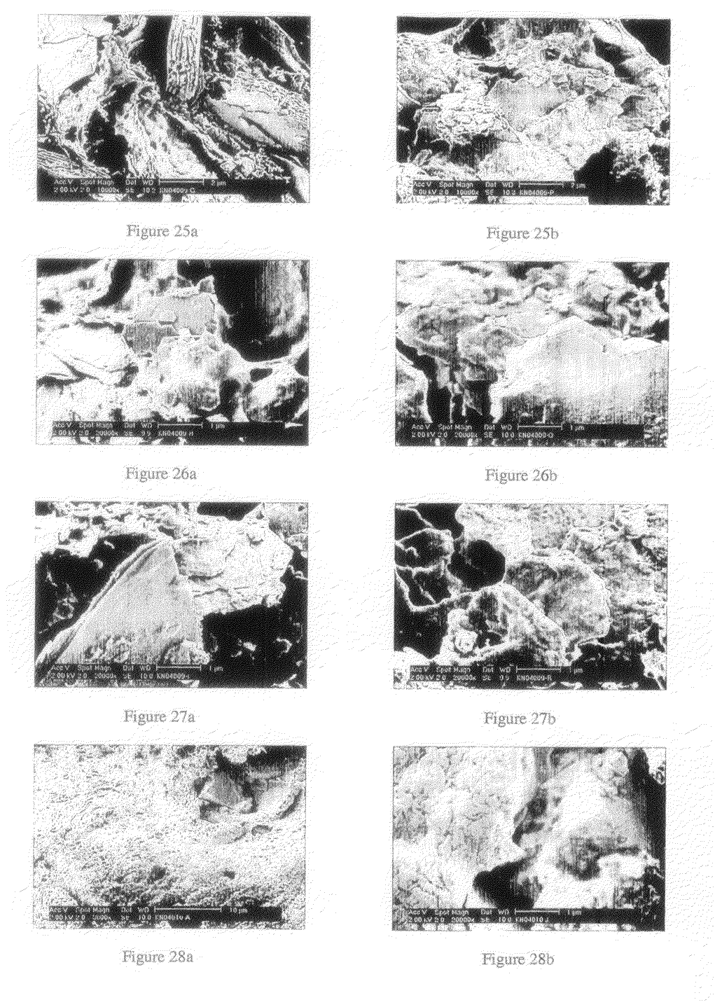

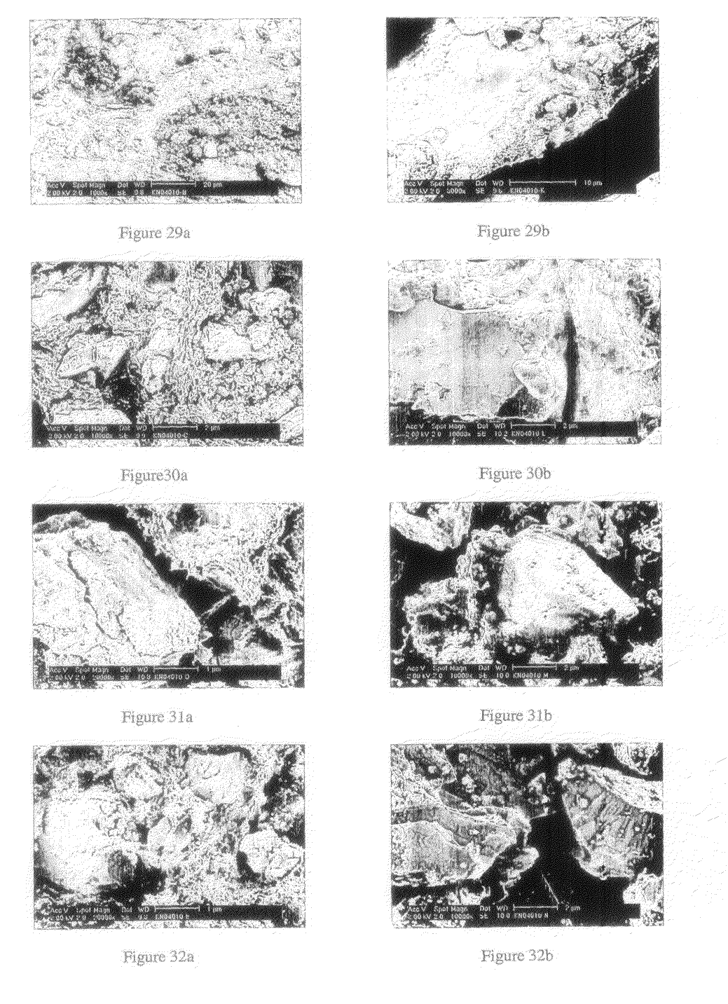

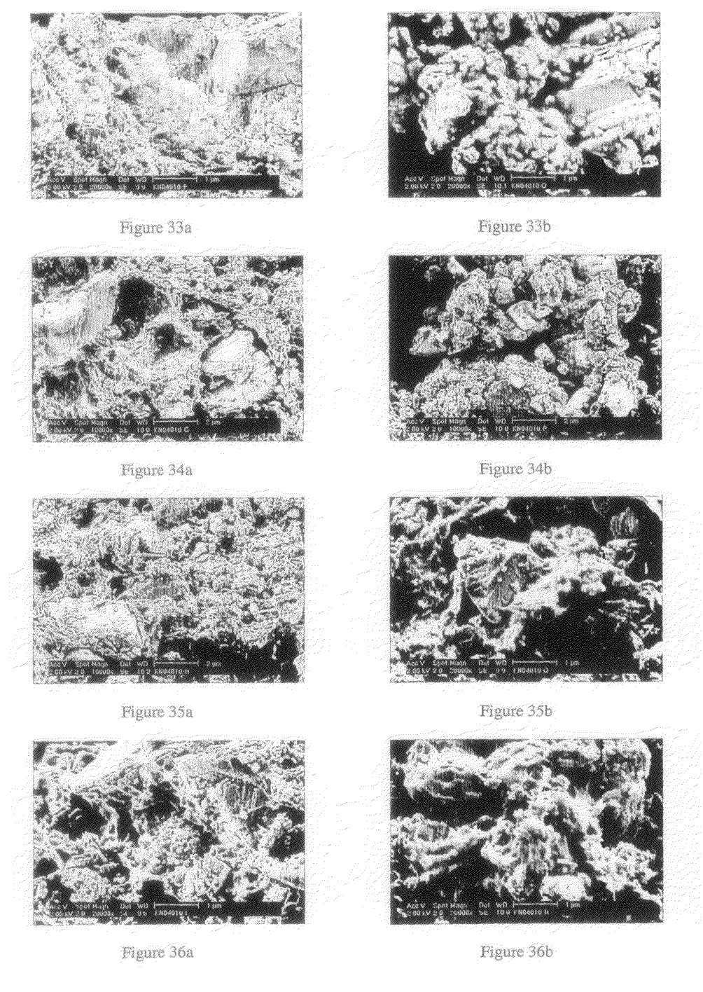

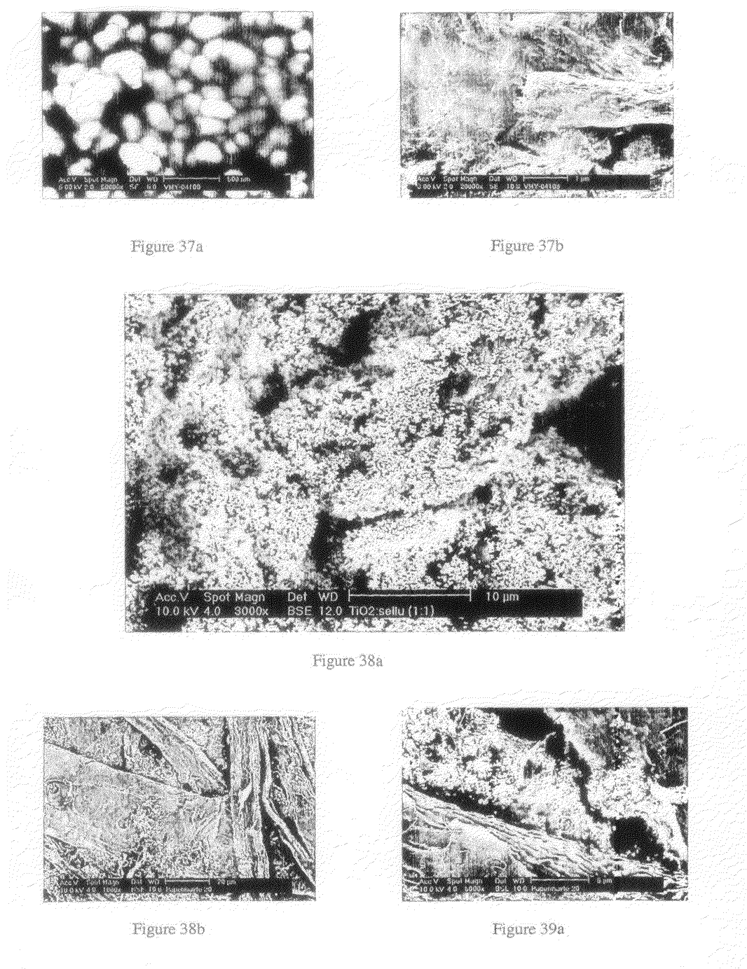

### DETAILED DESCRIPTION OF THE INVENTION

According to the invention there is provided composite materials comprising a continuous phase of a water-insoluble polysaccharide and particles of one or several inert materials, said inert material being a light scattering material. The composite material can be in form of particles, flocs, monolith, fibers, film as well as microspheres. The composite material can comprise of 0.01-99.99% by weight of water-insoluble polysaccharide and 0.01-99.99% by weight of inert light scattering material particles. Preferably, the composite material comprises of 3-97% by weight of water-insoluble polysaccharide and 3-97% by weight of inert light scattering material particles. More preferably, said composite material comprises of 40-97% by weight of inert light scattering material particles. Most preferably, said composite material comprises of 70-97% by weight of inert light scattering material particles.

The term “water-insoluble polysaccharide material” as used herein refers to cellulose, chitin, or mixtures thereof. With cellulose and chitin is hereby meant different grades and types of said polysaccharide polymers, these being chemically cellulose or chitin. These polysaccharide polymers are chemically non-derivatized materials, i.e. they are not subjected to any degree of esterification, etherification or other chemical modifications. However, both cellulose and chitin can be slightly oxidized as a result of bleaching procedures. Such minor structural changes don't affect their solubilities, fibrous structures, optical or any other beneficial properties and are commonly present in almost all pulp grades employed in paper and board manufacturing. Thus, cellulose can be any type of fibrous cellulose, wood pulp, linters, paper, microcrystalline cellulose, hemicellulose, cotton balls and regenerated cellulose with retained or substantially retained degree of polymerization (DP). Such regenerated cellulose is for example cellulose dissolved into ionic liquid and precipitated therefrom with a non-solvent for the cellulose.

The term “light scattering materials” as used herein refers to materials which have light scattering and other beneficial optical (opacity, brightness, whiteness, absorption capacity etc.) as well as physical properties in paper and board manufacturing. The light scattering materials are selected from the group consisting of titanium dioxide, kaolin clay, calcinated clay, talc, gypsum, calcium carbonate, hydrated aluminum oxide, sodium alumino silicate, calcium alumino silicate, barium sulfate, hydrated aluminum potassium silicate, diatomaceous earth, calcium oxalate, and zinc oxide. The inert light scattering material particles can have inorganic or organic nature.

One, two, three, four, five, six, seven or whichever number of light scattering materials can be applied in said composite materials together with cellulose and/or chitin. The light scattering material has an average particle size of 0.15 μm to 50 μm. Preferably said particles have an average particle size of 0.15 μm to 8 μm.

In one preferred embodiment of the invention, titanium oxide is employed as a light scattering material. Pigment forms of both anatase and rutile titanium dioxide can be applied. Said pigments can be uncoated or uncoated. Nano-scale titanium dioxide (≦100 nm) is not a light scattering material, and thus not usable in present invention. Preferably, when an anatase form of titanium dioxide is employed as light scattering material particle, said pigment has an average crystal size of 180 nm. Such a product is for example commercial pigment Kemira AN. When a rutile form of titanium dioxide is employed as light scattering material particle, said pigment has an average crystal size of 220 nm. One such product is for example commercial pigment Kemira 660. The upper limit of crystal size is not limited, however.

In another preferred embodiment of the invention, calcium carbonate particles are employed as a light scattering material. Calcium carbonate can be in its calcite, aragonite, or even in its vaterite form. For example, it can be ground calcium carbonate (GCC), or synthetic precipitated calcium carbonate (PCC). In a still another preferred embodiment of the invention, kaolin clay particles are employed as a light scattering material. For example, kaolin clay can be in the form of natural mineral, or it can be calcinated, delaminated, or high bulk kaolin clay.

According to the invention, there is also provided a process for producing a composite material based on water-insoluble polysaccharide comprising mixing the water-insoluble polysaccharide with an ionic liquid solvent to dissolve said polysaccharide, said solution being substantially free of water, organic solvent or nitrogen containing base, and then mixing said dissolved polysaccharide with the particles of the light scattering material at a temperature and for a period sufficient to disperse particles substantially homogeneously therein, and subsequently separating the composite material from the resulted dispersion. The phrase “substantially free of water” means that not more than a few percent by weight of water is present in the polysaccharide ionic liquid solution. Preferably, the water content is less than 1 percent by weight.

The dissolution of water-insoluble polysaccharide material can be assisted by applying microwave irradiation and/or pressure. The pressure is preferably at most 2.0 Mpa and more preferably between 1.5 Mpa and 2.0 Mpa. The dissolution can also be conducted in ultrasonic bath.

The dissolution of said polysaccharide material can be carried out at a temperature between 0° C. and 250° C., preferably at a temperature between 10° C. and 150° C., such as between 20° C. and 130° C. If microwave irradiation is applied, the heating can be carried out be means of this irradiation. The solution is agitated until complete or substantially complete dissolution is obtained.

The dispersing temperature of the inert light scattering material particles is preferably at least 50° C., more preferably at least 60° C. The dispersing temperature can be between 30° C. and 210° C., preferably between 70° C. and 130° C. The dispersing time is preferably at least 3 minutes. The dispersing time can be between 2 minutes and 10 hours.

The ionic liquid solvent is molten at a temperature between −100° C. and 200° C., preferably at a temperature of below 170° C., and more preferably between −50° C. and 120° C. The cation of the ionic liquid solvent is preferably a five- or six-membered heterocyclic ring optionally being fused with a benzene ring and comprising as heteroatoms one or more nitrogen, oxygen, or sulfur atoms. The heterocyclic ring can be aromatic or saturated.

The cation can be one of the following:

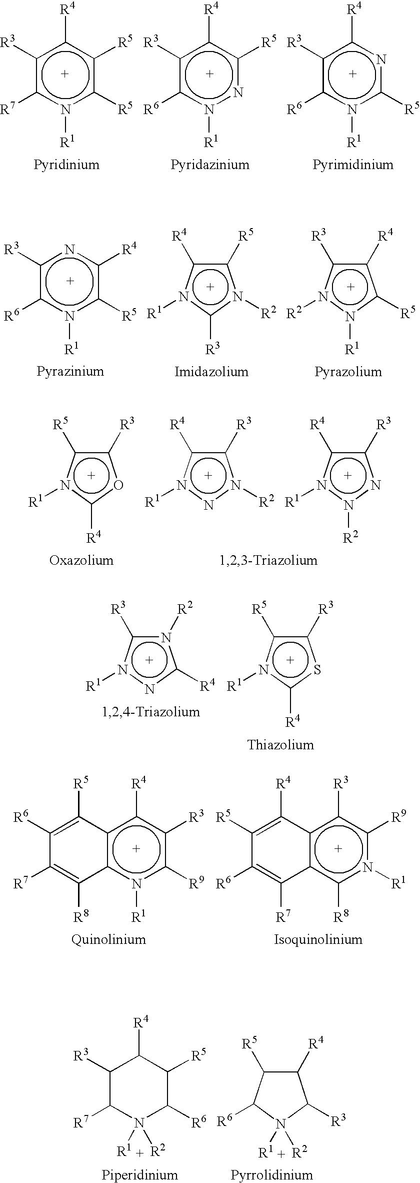

wherein R¹ and R² are independently a C₁-C₆ alkyl or C₂-C₈ alkoxyalkyl group, and R³, R⁴, R⁵, R⁶, R⁷, R⁸ and R⁹ are independently hydrogen, a C₁-C₆ alkyl, C₂-C₈ alkoxyalkyl or C₁-C₈ alkoxy group or halogen.

In the above formulae R¹ and R² are preferably both C₁-C₄ alkyl, and R³-R⁹, when present, are preferably hydrogen. C₁-C₆ alkyl includes methyl, ethyl, propyl, iso-propyl, butyl, sec-butyl, tert-butyl, pentyl, the isomers of pentyl, hexyl and the isomers of hexyl. C₁-C₆ alkyl can also include a double bound. C₁-C₈ alkoxy contains the above C₁-C₈ alkyl bonded to an oxygen atom. C₂-C₈ alkoxyalkyl is an alkyl group substituted by an alkoxy group, the total number of carbon atoms being from two to eight. C₂-C₈ alkoxyalkyl can herein also refer to polyether moiety.

Halogen is preferably chloro, bromo, or fluoro, especially chloro. Preferred cations have following formulae:

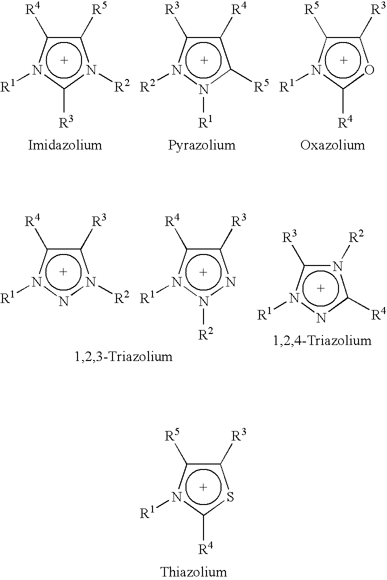

wherein R¹-R⁵ are as defined above.

An especially preferred cation is the imidazolium cation having the formula:

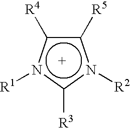

wherein R¹-R⁵ are as defined above. In this formula R³-R⁵ are preferably each hydrogen and R¹ and R² are independently C₁-C₆ alkyl or C₂-C₈ alkoxyalkyl. More preferably one of R¹ and R² is methyl and the other is C₁-C₆ alkyl. In this formula R³ can also be halogen, preferably chloro.

The anion of the ionic liquid solvent can be one of the following:

halogen such as chloride, bromide or iodide;
pseudohalogen such as thiocyanate or cyanate;
perchlorate;
C₁-C₆ carboxylate such as formate, acetate, propionate, butyrate, lactate, pyruvate, maleate, fumarate, or oxalate;
nitrate;

C₂-C₆ carboxylate substituted by one or more halogen atoms such as trifluoroacetic acid;

C₁-C₆ alkyl sulfonate substituted by one or more halogen atoms such as trifluoromethane sulfonate (triflate); tetrafluoroborate BF₄⁻; or phosphorus hexafluoride PF₆⁻.

The above halogen substituents are preferably fluoro.

The anion of the ionic liquid solvent is preferably selected among those providing a hydrophilic ionic liquid solvent. Such anions include halogen, pseudohalogen or C₁-C₆ carboxylate. The halogen is preferably chloride, bromide or iodide, and the pseudohalogen is preferably thiocyanate or cyanate.

If the cation is a 1-(C₁-C₆-alkyl)-3-methyl-imidazolium, the anion is preferably a halide, especially chloride.

A preferred ionic liquid solvent is 1-butyl-3-methyl-imidazolium chloride (BMIMCl) having a melting point of about 60° C.

Another type of ionic liquid solvent useful in the present invention is an ionic liquid solvent wherein the cation is a quaternary ammonium salt having the formula

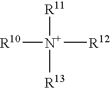

wherein R¹⁰, R¹¹, R¹² and R¹³ are independently a C₁-C₃₀ alkyl, C₃-C₈ carbocyclic, or C₃-C₈ heterocyclic group, or C₂-C₃₀ alkoxyalkyl, and the anion is halogen, pseudohalogen, perchlorate, C₁-C₆ carboxylate or hydroxide.

The C₁-C₃₀ alkyl group can be linear or branched and is preferably a C₁-C₁₂ alkyl group. C₁-C₆ alkyl can also include a double bound.

The C₃-C₈ carbocyclic group includes cycloalkyl, cycloalkenyl phenyl, benzyl and phenylethyl groups.

The C₃-C₈ heterocyclic group can be aromatic or saturated and contains one or more heteroatoms selected from the group consisting of nitrogen, oxygen, and sulfur.

C₂-C₃₀ alkoxyalkyl is an alkyl group substituted by an alkoxy group, the total number of carbon atoms being from two to thirty. C₂-C₃₀ Alkoxyalkyl can herein also refer to polyether moiety.

The polysaccharide material and the inert light scattering material particles can be present in the dispersion in an amount of about 1% to about 71% by weight of the ionic liquid dispersion. Preferably the amount is from about 10% to about 50% by weight. The inert light scattering material particles represent an amount of 0.005% to 70% by weight of the resulting ionic liquid dispersion.

After homogeneously dispersing the inert light scattering material particles into polysaccharide ionic liquid solution, the composite product can be separated from the dispersion by adding a non-solvent for the composite product to precipitate said composite material. The non-solvent should be miscible with the ionic liquid solvent. Said non-solvent is preferably water or an alcohol, such as a C₁-C₆ alkanol, for example methanol, ethanol, propanol or isopropanol. Also other non-solvents, such as ketones (e.g., acetone), acetonitrile, polyglycols and ethers or appropriate mixtures thereof can be employed. The morphology, density and surface properties of the composite product can be adjusted by a selection of both the inert light scattering material particles, non-solvent and temperatures applied in the precipitation of the composite materials. Preferably, the non-solvent is employed near its boiling point the dispersion having substantially the same temperature. According to invention, the composite morphology can also be adjusted by bubbling gas into the ionic liquid dispersion before and in connection with the precipitation of said composite material. The elevated temperatures usually lead to lower densities of the composite product. In the precipitation step or after precipitation and before use, the particle size of the composite can be tuned by milling or grinding. The composite material can also be manufactured in form of fibers by carrying out the admixing of said dispersion with a non-solvent for the composite material by extruding said dispersion through a die and into said non-solvent.

In one embodiment of the invention, there is provided a process for paper and board manufacturing, wherein composite material consisting of a continuous phase of a water-insoluble polysaccharide and particles of one or several light scattering materials is used. The paper or board end product can be prepared partially or substantially completely from said composite material. The water-insoluble polysaccharide can be cellulose or chitin or a mixture of cellulose and chitin. In this process, the composite material comprises 0.01-99.99% by weight of water-insoluble polysaccharide and 0.01-99.99% by weight of inert light scattering material particles. Preferably, the composite material comprises 3-97% by weight of water-insoluble polysaccharide and 3-97% by weight of inert light scattering material particles. More preferably, the composite material comprises of 40-97% by weight of inert light scattering material particles. Most preferably, the composite material comprises of 70-97% by weight inert light scattering material particles. The morphology of the composite material can be adjusted by selection of light scattering material (nature and degree of content) particles, non-solvent, and temperatures applied in the precipitation of said composite material. Temperatures of both non-solvent and dispersion can be tuned. The composite product morphology (density, porosity etc.) is preferably further tuned by bubbling gas into said dispersion both before and simultaneously with the precipitation step. Safe and cheap gases are for instance air, nitrogen, CO₂, and mixtures thereof. The choice of gas is not limited to these gases. The gas can be a constituent of the present composite materials to be used in paper and board manufacturing.

The light scattering materials are selected from the group consisting of titanium dioxide, kaolin clay, calcinated clay, talc, gypsum, calcium carbonate, hydrated aluminum oxide, sodium alumino silicate, calcium alumino silicate, barium sulfate, hydrated aluminum potassium silicate, diatomaceous earth, calcium oxalate, and zinc oxide. The inert light scattering material particles can have inorganic or organic nature. Preferably, the light scattering material is selected from the group consisting of titanium dioxide, calcium carbonate, and kaolin clay.

The light scattering material has an average particle size of 0.15 μm to 50 μm. Preferably said particles have an average particle size of 0.15 μm to 8 μm. When employing anatase form titanium dioxide pigments, the preferred crystal size is 180 nm. When employing rutile form titanium dioxide pigments, the preferred crystal size is 220 nm. Titanium dioxide pigments can be uncoated or coated. They can also be larger than 220 nm, but are preferably smaller than 500 nm. Nano-scale titanium dioxide (≦100 nm) is not a light scattering material, and can thus not be used as a composite component to be applied in said paper or board manufacturing process.

Preferably, calcium carbonate particles are employed as light scattering material. Calcium carbonate can be in its calcite, aragonite, or even in its vaterite form. It can be ground calcium carbonate (GCC), or synthetic precipitated calcium carbonate (PCC). In a further preferred embodiment of the invention, kaolin clay particles are employed as light scattering material. Kaolin clay can be in the form of natural mineral, or it can be calcinated, delaminated or high bulk kaolin clay.

When employing chitin in paper or board manufacturing process, it is possible to prepare highly biodegradable end products with fibrous nature and good optical properties.

According to the invention, the composite material can be used as substantially organic filler in the manufacture of both paper and board. The material is precipitated, ground or milled to appropriate size prior to use. The composite material comprises 70-99.99% by weight of water-insoluble polysaccharide. Preferably, the composite material comprises 97-99.99% by weight of water-insoluble polysaccharide material. In some exceptional cases, the composite material can comprise even higher degree of polysaccharide material. Preferably, the polysaccharide is cellulose, but it can also be a mixture of cellulose and chitin, or chitin alone. The morphology of said composite material is always controlled by selection of inert light scattering material particles (degree of content, nature etc.), non-solvent, and temperatures applied in the said composite material. Temperatures of both non-solvent and dispersion can be tuned. As stated earlier, the product morphology is preferably adjusted with bubbling gas into dispersion.

When composite material comprises 70-99.99% by weight of water-insoluble polysaccharide, or preferably even more, i.e., 97-99.99% by weight of water-insoluble polysaccharide material, the composite product morphology can presumably be adjusted to desired density and porosity also employing materials being not inert light scattering material particles. Such particles might preferably be of inorganic nature, but the organic material particles can't be omitted. Herein, the gas employed in the composite material preparation may become an important constituent of said composite material. Preferably, the density of said composite products is adjusted to a decreased level.

The composite material can also be used as substantially inorganic filler in paper and board manufacturing accomplishing the preparation of high filler end products.

In still another embodiment of the invention, the paper or board product is produced substantially of said composite material.

According to the invention, the composite material can also be used as pigment in the manufacture of both paper and board.

In consequence of the invention, the main advantages of the new composite materials, method for their preparation and use in paper and board manufacturing are:
polysaccharide derived composite materials in which the proportion of whichever inert light scattering material particles can be tuned almost unlimitedly;
possibility to employ inert light scattering material particles in a large variety of size;
the composite materials can be prepared in several different forms, i.e., as particles, flocs, monolith, fibers, and films;
fast and economical preparation process of the composite materials with unexpectedly high degrees of both dissolved polysaccharide and especially dispersed light scattering particles in workable ionic liquid dispersion;
the particle size of light scattering materials is retained in the composite product thus retaining the light scattering effect of said particles;
fast and economical separation of the composite materials by precipitating the prepared composite material by adding a non-solvent for the composite, and further, a simple, energy efficient drying procedure of the products;
   the composite product morphology can be adjusted by selection of inert light scattering material particles, non-solvent, temperatures of non-solvent and ionic liquid dispersion as well as optionally by bubbling gas into said dispersion before and in connection with the precipitation process

Exceptionally low contents of light scattering material;
High heat capacity products, which can be employed in energy production by burning said material;
Convenient low weight products reducing transportation costs and environment;
Reduced abrasion of paper, board and printing machines due to soft, organic materials;
   the composite product can be prepared in form of fibers by carrying out the precipitation by extruding the ionic liquid dispersion through a die and into non-solvent for the composite product;
   the retention of inert light scattering material particles can be dramatically enhanced in paper and board manufacturing;
   due to enhanced retention of inert light scattering material particles,
paper and board manufacturing process becomes cheaper and more environmentally friendly;
lower weight paper/board grades can be manufactured with retained and/or improved properties;
the proportion of light scattering materials can be raised over conventional levels leading to less need for expensive fiber materials;
the consumption of expensive retention agents can be diminished or eliminated;
   possibility to employ inert light scattering material particles with exquisite properties in composite materials presently not adaptable to paper and board manufacturing;
   problems associated with lower degree of bonding are avoided,
good tensile strength of the paper/board product with simultaneously enhanced opacity;
   problems associated with partial solubility of calcium carbonate into water in paper/board manufacturing are greatly diminished.

### EXAMPLES

The percentages in this specification refer to % by weight unless otherwise specified. The ionic liquid (BMIMCl) was purchased from Fluka. Due to its hygroscopicity, the ionic liquid was always dried prior use by agitating it in vacuum at 80° C. for at least three hours. Also all the employed cellulose materials were pre-dried in an oven at 105° C. for approximately two hours.

The prepared composite materials were washed with same non-solvent as employed in the precipitation step, followed by air-drying and/or vacuum drying the said materials at room temperature. When ethanol was used as a non-solvent, essentially neat ethanol (AA-grade 99.5%, Primalco) was employed. The prepared composite materials were studied with scanning electron microscope (SEM). FIG. 37a represents titanium dioxide (coated rutile, commercial Kemira TiO₂ pigment 660) as such, FIG. 37b representing microcrystalline cellulose fibers as such. Employed calcium carbonate was micronized Mikhart-type calcium carbonate.

### Preparation of Composite Materials

In the first sets of composite materials, a 10% cellulose BMIMCl-working solution was prepared by mixing 5 grams of microcrystalline cellulose (20 μm, Sigma-Aldrich) into 50 grams of BMIMCl by agitating the resulting mixture at 80° C. overnight. The resulting clear cellulose solution was divided into 18 different batches in their own sealed flasks, which in turn were kept agitated at 80° C. The addition of inert light scattering material particles, i.e., different forms of TiO₂, kaolin, different grades of CaCO₃, etc., always resulted in a drop in the viscosity of the working solution.

In these first sets of composite materials, the prepared products were always washed with 20-30 ml of room temperature non-solvent under vigorous stirring. No traces of either the water-insoluble polysaccharide material or of inert light scattering material particles were found in remaining ionic liquid or non-solvent.

### Cellulose-TiO₂ (Coated Rutile, Commercial Kemira TiO₂ Pigment 660) Composite Material

### Example 1

28 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 9:1 cellulose-TiO₂ composite material 1.

### Example 2

64 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 8:2 cellulose-TiO₂ composite material 2.

### Example 3

107 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 7:3 cellulose-TiO₂ composite material 3.

### Example 4

167 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 6:4 cellulose-TiO₂ composite material 4.

### Example 5

250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 5:5 cellulose-TiO₂ composite material 5.

### Example 6

375 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 4:6 cellulose-TiO₂ composite material 6.

### Example 7

583 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 3:7 cellulose-TiO₂ composite material 7.

### Example 8

1000 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 2:8 cellulose-TiO₂ composite material 8.

### Example 9

2250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 1:9 cellulose-TiO₂ composite material 9.

### Example 10

28 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 9:1 cellulose-TiO₂ composite material 10.

### Example 11

64 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 8:2 cellulose-TiO₂ composite material 11.

### Example 12

107 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 7:3 cellulose-TiO₂ composite material 12.

### Example 13

167 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 6:4 cellulose-TiO₂ composite material 13.

### Example 14

250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 5:5 cellulose-TiO₂ composite material 14.

### Example 15

375 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 4:6 cellulose-TiO₂ composite material 15.

### Example 16

583 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml. of room temperature EtOH was added under agitation to give the 3:7 cellulose-TiO₂ composite material 16.

### Example 17

1000 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 2:8 cellulose-TiO₂ composite material 17.

### Example 18

2250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 1:9 cellulose-TiO₂ composite material 18.

### Cellulose-TiO₂ (Anatase, Commercial Kemira TiO₂ Pigment) Composite Material

### Example 19

28 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 9:1 cellulose-TiO₂ composite material 19.

### Example 20

64 mg of TiO₂ was dispersed into 5 ml of clear cellulose BMIMCl-solution (containing 250 mg of cellulose) to give an opaque, v. After vigorous stirring for 20 minutes at 80° C., 20 ml of tepid water was added under agitation to give the 8:2 cellulose-TiO₂ composite material 20.

### Example 21

107 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 7:3 cellulose-TiO₂ composite material 21.

### Example 22

167 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 6:4 cellulose-TiO₂ composite material 22.

### Example 23

250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 5:5 cellulose-TiO₂ composite material 23.

### Example 24

375 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 4:6 cellulose-TiO₂ composite material 24.

### Example 25

583 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 3:7 cellulose-TiO₂ composite material 25.

### Example 26

1000 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 2:8 cellulose-TiO₂ composite material 26.

### Example 27

2250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of tepid water was added under agitation to give the 1:9 cellulose-TiO₂ composite material 27.

### Example 28

28 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 9:1 cellulose-TiO₂ composite material 28.

### Example 29

64 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 8:2 cellulose-TiO₂ composite material 29.

### Example 30

107 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 7:3 cellulose-TiO₂ composite material 30.

### Example 31

167 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 6:4 cellulose-TiO₂ composite material 31.

### Example 32

250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 5:5 cellulose-TiO₂ composite material 32.

### Example 33

375 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 4:6 cellulose-TiO₂ composite material 33.

### Example 34

583 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 3:7 cellulose-TiO₂ composite material 34.

### Example 35

1000 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 2:8 cellulose-TiO₂ composite material 35.

### Example 36

2250 mg of TiO₂ was dispersed into 5 ml of clear cellulose BMIMCl-solution (containing 250 mg of cellulose) to give an opaque, homogeneous dispersion. After vigorous stirring for 20 minutes at 80° C., 20 ml of room temperature EtOH was added under agitation to give the 1:9 cellulose-TiO₂ composite material 36.

### Cellulose-Kaolin Clay Composite Material

### Example 37

28 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 9:1 cellulose-kaolin clay composite material 37.

### Example 38

64 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 8:2 cellulose-kaolin clay composite material 38.

### Example 39

107 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 7:3 cellulose-kaolin clay composite material 39.

### Example 40

167 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 6:4 cellulose-kaolin clay composite material 40.

### Example 41

250 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 5:5 cellulose-kaolin clay composite material 41.

### Example 42

375 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 4:6 cellulose-kaolin clay composite material 42.

### Example 43

583 mg of TiO₂ was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 3:7 cellulose-kaolin clay composite material 43.

### Example 44

1000 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 2:8 cellulose-kaolin clay composite material 44.

### Example 45

2250 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of tepid water was added under agitation to give the 1:9 cellulose-kaolin clay composite material 45.

### Example 46

28 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 9:1 cellulose-kaolin clay composite material 46.

### Example 47

64 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 8:2 cellulose-kaolin clay composite material 47.

### Example 48

107 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 7:3 cellulose-kaolin clay composite material 48.

### Example 49

167 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 6:4 cellulose-kaolin clay composite material 49.

### Example 50

250 mg of TiO₂ was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 5:5 cellulose-kaolin clay composite material 50.

### Example 51

375 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 4:6 cellulose-kaolin clay composite material 51.

### Example 52

583 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 3:7 cellulose-kaolin clay composite material 52.

### Example 53

1000 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 2:8 cellulose-kaolin clay composite material 53.

### Example 54

2250 mg of kaolin clay was dispersed into 5 ml of clear cellulose BMIMCl-solution (containing 250 mg of cellulose) to give a non-transparent, homogeneous dispersion. After vigorous stirring for 20 minutes at 80° C., 20 ml of room temperature EtOH was added under agitation to give the 1:9 cellulose-kaolin clay composite material 54.

### Cellulose-Calcium Carbonate Composite Material

### Example 55

28 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 9:1 cellulose-calcium carbonate composite material 55.

### Example 56

64 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 8:2 cellulose-calcium carbonate composite material 56.

### Example 57

107 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 7:3 cellulose-calcium carbonate composite material 57.

### Example 58

167 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 6:4 cellulose-calcium carbonate composite material 58.

### Example 59

250 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 5:5 cellulose-calcium carbonate composite material 59.

### Example 60

375 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 4:6 cellulose-calcium carbonate composite material 60.

### Example 61

583 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 3:7 cellulose-calcium carbonate composite material 61.

### Example 62

1000 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 2:8 cellulose-calcium carbonate composite material 62.

### Example 63

2250 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of tepid water was added under agitation to give the 1:9 cellulose-calcium carbonate composite material 63.

### Example 64

28 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 9:1 cellulose-calcium carbonate composite material 64.

### Example 65

64 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 8:2 cellulose-calcium carbonate composite material 65.

### Example 66

107 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 7:3 cellulose-calcium carbonate composite material 66.

### Example 67

167 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 6:4 cellulose-calcium carbonate composite material 67.

### Example 68

250 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 5:5 cellulose-calcium carbonate composite material 68.

### Example 69

375 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 4:6 cellulose-calcium carbonate composite material 69.

### Example 70

583 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 3:7 cellulose-calcium carbonate composite material 70.

### Example 71

1000 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 2:8 cellulose-calcium carbonate composite material 71.

### Example 72

2250 mg of calcium carbonate was dispersed into 5 ml of clear cellulose BMIMCl-solution (containing 250 mg of cellulose) to give a non-transparent, bright white, homogeneous dispersion. After vigorous stirring for 20 minutes at 80° C., 20 ml of room temperature EtOH was added under agitation to give the 1:9 cellulose-calcium carbonate composite material 72.

### Example 73

250 mg of titanium dioxide (coated rutile, commercial Kemira TiO₂ pigment 660) were mixed together with 250 mg of cellulose to give a sample describing the precipitation of the titanium dioxide particles in a traditional manner. As can be seen from the picture 38a, titanium dioxide particles precipitate on the fiber surface, forming no composite structure.

### Example 74

Preparation of 1:1 Cellulose-TiO₂ (coated rutile, commercial Kemira TiO₂ pigment 660) composite material for hand sheets and manufacture of said hand sheets.

In the second set of composite materials, a 10% cellulose BMIMCl-working solution was prepared by mixing 100 grams of microcrystalline cellulose (20 μm, Sigma-Aldrich) into 1000 grams of BMIMCl by agitating the resulting mixture at 80° C. overnight. The resulting clear cellulose solution was divided into two different batches, KN04014-A and KN-04014-B, both into their own reactors. The solutions kept agitated at 80° C. and to both solutions, 50 grams of TiO₂ (Kemira 660) was dispersed to give an opaque, homogeneous dispersion.

After vigorous stirring for 20 minutes at 80° C., the product in batch KN04014-A was precipitated by adding 4.5 l of boiling water to the solution under vigorous stirring. The formed composite was washed with 1 l of hot water, dried and used in hand sheet manufacture. The second batch, namely KN04014-B was treated in the same manner employing boiling ethanol in both precipitation and washing steps (4.5 l+1 l).

The elemental analysis revealed no nitrogen being present in the prepared composite materials, thus confirming said composites being free of possible ionic liquid traces.

Laboratory handsheets of 56 g/m target grammage were formed on the Ernst Haage sheet former both with the composite material and with reference commercial TiO₂ (Kemira, TiO₂ pigment 660). Both composite materials (KN04014-A and (KN04014-B) were ground prior to use in a planetary ball mill (Pulverisette 5, Fritsch) to achieve the particle size of 30 μm each.

The furnish of handsheet preparation consisted of 70% of thermomechanical pulp (TMP) and 30% of bleached pine kraft pulp (delivered by UPM-Kymmene), consistency of the mass being adjusted to be 0.5%. The amount of loaded TiO₂ in the sheets was controlled by varying the amount of loaded composite material or reference pigment so that target TiO₂ levels were 0%, 20%, 40% and 60% both for composite and reference filler.

Two series of handsheets were produced: with and without aid of retention agent. For the former series, Fennopol K3400R (Kemira) was applied as a retention agent in an amount of 150 mg/kg. Thus prepared handsheets were conditioned and tested under Tappi standard conditions of 23° C. and 50% relative humidity. The sheets were tested according to the appropriate ISO standards: ISO 2471 was applied for the ISO opacity. Opacity measurements were performed using Minolta CM 3700d spectrophotometer. For ash analysis the sheets were burned in oven at 900° C. for two hours.

The measured opacities of hand sheets with composite materials as compared to TiO₂ are presented in table 1.

TABLE 1

| | TiO₂, according to | | | KN0414-A, according to | | | KN0414-B, according to | | |
|---|---|---|---|---|---|---|---|---|---|
| | loading | | | TiO₂ loading | | | TiO₂ loading | | |
| Opacity | 20% | 40% | 60% | 20% | 40% | 60% | 20% | 40% | 60% |
| with retention | 96 | 98 | 99 | 95 | 98 | — | 95 | 98 | 99 |
| agent | | | | | | | | | |
| without retention | 95 | 97 | 99 | 95 | 98 | 99 | 93 | 97 | 97 |
| agent | | | | | | | | | |

As can be seen from the results, with this composite particle size and these titanium dioxide loadings, the results were fully comparable to employing titanium dioxide as such to work as light scattering material.

In the next table (Table 2), the retention of titanium dioxide both without retention agent and with retention agent is compared to results wherein different degrees of titanium dioxide are loaded in form of composites.

TABLE 2

| material | TiO₂ | | KN0414-A | | KN0414-B | |
|---|---|---|---|---|---|---|
| Loading | 20% | 40% | 20% | 40% | 20% | 40% |
| Retention, with | 74 | 97 | 94 | 92 | 98 | 97 |
| retention agent | | | | | | |
| Retention, | 37 | 37 | 93 | 93 | 90 | 90 |
| without retention | | | | | | |
| agent | | | | | | |

As can be seen from the results, the retention of titanium dioxide was dramatically improved while employing composite materials in hand sheets. The results also reveal, in contrast to prior art technology, that the use of retention agents is not necessary when employing composite materials as fillers in paper manufacturing.

### Example 75

In the next set of hand sheets, the employed 1:1 TiO₂:cellulose composite material (coated rutile, commercial Kemira TiO₂ pigment 660) was prepared in same manner as in example 74, the cellulose starting material now being kraft pulp (pine/birch 1:2). The composite material was precipitated with boiling water at approximately 100° C., dried and milled to two different particle sizes, namely 6.9 g/m (KN04015/1) and 4.5 μm (KN04015/2). In hand sheets, these composite materials were compared to the use of sole titanium dioxide pigment Kemira 660 as a light scattering material. Handsheets were prepared with 80 g/m2 target grammage.

Furnish for hand sheet consisted of kraft pulp, pine/birch 1:2 (Kymi Paper, paper machine 8) and in deionized water preslurried composite materials, the consistency of mass being adjusted to 0.53% with deionized water.

The pH of the resulting slurry was adjusted to approximately 8.0.

Retention test were carried out with Dynamic Drainage Jar equipment (DDJ). The experiments were conducted stepwise in the following manner:

at time of 0 s, mixing rate being at 1500 rpm, the 0.5% pulp-composite sample was poured into a 500 ml decanter flask;
at time of 10 s, the polymer was mixed into the pulp-composite sample;
at time of 45 s, a filtrate sample of 100 ml was collected.

The employed wire was a DDj-wire 125P, the size of the holes being 200 mesh. The applied polymer was Fennopol K3400R (Kemira), which is a cationic polyacrylamide, being a copolymer of acrylamide and acryloyloxyethyltrimethylammoniumchloride with a charge of approximately 1 mekv/g and having a molecular weight approximately 7 Mg/mol (PAM1). Polymer dosages are noted as added polymer per pulp-composite material (dry-matter content), g/t. First pass retentions were determined by filtering of the solid material, and subsequently drying said material in oven at 100-105° C. The ash retentions for pulp-composite hand sheets and filtrates were composed by burning the samples in oven at 900° C. for two hours.

In Table 3 and Chart 1 we can see that the first pass retentions (%) when employing composite materials KN04015/1 (KOMP1) and KN04015/2 (KOMP 2) are significantly better when compared to trials employing sole TiO₂ as light scattering material. The differences are especially big with no or low loadings of retention aid K3400R.

TABLE 3

Retention aid (g/t)

| filler material | 0 g/t | 100 g/t | 300 g/t | 500 g/t |
|---|---|---|---|---|
| TiO₂ | 64.3% | 70.4% | 77.0% | 81.0% |
| KN04015/1 | 72.9% | 78.0% | 81.8% | 85.3% |
| KN04015/2 | 71.9% | 73.8% | 78.1% | 81.1% |

In next test, the ash retentions (%) were determined. The results in Table 4 and in Chart 2 reveal similar results in terms of retention as with first pass retention. The retention of titanium dioxide is greatly enhanced when these inert light scattering material particles are delivered into end product in form of composite materials.

TABLE 4

Retention aid (g/t)

| filler material | 0 g/t | 100 g/t | 300 g/t | 500 g/t |
|---|---|---|---|---|
| TiO₂ | 0% | 17.6% | 37.9% | 49.7% |
| KN04015/1 | 10.8% | 26.1% | 43.6% | 45.9% |
| KN04015/2 | 9.6% | 21.8% | 36.5% | 44.6% |

In next set of tests the opacities were determined in terms of ash content (%). High opacities were obtained with already low titanium dioxide loadings via composite materials. To reach similar opacities with sole titanium dioxide as with composite materials, almost threefold weight contents of titanium dioxide were required. Fennopol K3400R was applied as a retention agent in an amount of 100 g/t. The results are presented in Table 5 and Chart 3.

TABLE 5

| Ash content | opacity %/% | | |
|---|---|---|---|
| TiO₂ | 3.2%/79.36% | 4.6%/81.00% | 13.3%/86.42% |
| KN04015/1 | 2.5%/82.62% | 5.3%/87.23% | |
| KN04015/2 | 2.7%/83.5% | 5.3%/88.11% | |

In next set of tests the scattering coefficients (%) were determined in terms of ash content (%). As in previous test with opacities, high values of scattering coefficient were obtained with already low titanium dioxide loadings via composite materials. To reach similar scattering coefficients with sole titanium dioxide as with composite materials, almost threefold weight contents of titanium dioxide were required. Fennopol K3400R was applied as a retention agent in an amount of 100 g/t. The results are presented in Table 6 and Chart 4.

TABLE 6

| Ash content | scattering coefficient %/% | | |
|---|---|---|---|
| TiO₂ | 3.2%/32.44% | 4.6%/34.70% | 13.3%/47.30% |
| KN04015/1 | 2.5%/35.64% | 5.3%/45.08% | |
| KN04015/2 | 2.7%/35.73% | 5.3%/43.86% | |

In the following set of tests the absorption coefficients (%) were determined in terms of ash content (%). As in previous test with opacities and scattering coefficients, high values for absorption coefficient were obtained with already low titanium dioxide loadings via composite materials. Fennopol K3400R was applied as a retention agent in an amount of 100 g/t. To reach similar absorption coefficients with sole titanium dioxide as with composite materials, approximately fivefold weight contents of titanium dioxide were required. The results are presented in Table 7 and Chart 5.

TABLE 7

| Ash content | absorption coefficient %/ | | |
|---|---|---|---|
| TiO₂ | 3.2%/0.19 | 4.6%/0.19 | 13.3%/0.28 |
| KN04015/1 | 2.5%/0.25 | 5.3%/0.36 | |
| KN04015/2 | 2.7%/0.31 | 5.3%/0.56 | |

In the following set of tests the tensile strengths (Nm/g) were determined in terms of opacities (%). The ash content was adjusted to 3%. When employing composite materials, greatly improved opacities were gained without any significant losses of tensile strength. This feature now accomplishes the improvement of optical properties without simultaneous degradation of physical properties, a phenomenon not possible with conventional methods. Fennopol K3400R was applied as a retention agent in an amount of 100 g/t. Zero-test represents situation without any filler material. The results are presented in Chart 6.

In the following set of tests the tensile strengths (Nm/g) were determined in terms of opacities (%), the ash content being adjusted to a higher level, namely 5%. Also here it could be clearly noted that where composite materials were employed, greatly improved opacities were gained without any significant losses of tensile strength. Also here, the results emphasize the improvement of optical properties without simultaneous degradation of physical properties, a phenomenon not possible with conventional methods. Fennopol K3400R was applied as a retention agent in an amount of 100 g/t. Zero-test represents situation without any filler material. The results are presented in Chart 7.

The hand sheets were also studied with SEM. The pictures (38b and 39a) reveal the composite material is within the fiber matrix being uniform part of the pulp material. This is due to fiber-fiber bonding. When using traditional techniques, the light scattering materials are precipitated over the fiber, being loose, separate particles among the fibrous pulp material.

1. A composite material comprising a continuous phase of a water-insoluble polysaccharide and particles of an inert material, wherein the inert material is a light scattering material.

2. The composite material according to claim 1, wherein the composite material is in the form of particles.

3. The composite material according to claim 1, wherein the composite material is in the form of flocs.

4. The composite material according to claim 1, wherein the composite material is in the form of a monolith.

5. The composite material according to claim 1, wherein the composite material is in the form of fibers.

6. The composite material according to claim 1, wherein the composite material is in the form of film.

7. The composite material of claim 1, comprising 0.01-99.99% by weight of water-insoluble polysaccharide and 0.01-99.99% by weight of inert light scattering material particles.

8. The composite material of claim 1, comprising 3-97% by weight of water-insoluble polysaccharide and 3-97% by weight of inert light scattering material particles.

9. The composite material of claim 1, comprising 40-97% by weight of inert light scattering material particles.

10. The composite material of claim 1, comprising 70-97% by weight of inert light scattering material particles.

11. The composite material of claim 1, wherein the water-insoluble polysaccharide is selected from the group consisting of cellulose, chitin, and mixtures thereof.

12. The composite material of claim 1, wherein the light scattering material is selected from the group consisting of titanium dioxide, kaolin clay, calcinated clay, talc, gypsum, calcium carbonate, hydrated aluminum oxide, sodium alumino silicate, calcium alumino silicate, barium sulfate, hydrated aluminum potassium silicate, diatomaceous earth, calcium oxalate, and zinc oxide.

13. The composite material according to claim 12, wherein the light scattering material has an average particle size of 0.15 μm to 50 μm.

14. The composite material according to claim 12, wherein the light scattering material has an average particle size of 0.15 μm to 8 μm.

15. The composite material according to claim 12, wherein the light scattering material is an anatase form titanium dioxide pigment with average crystal size of 180 nm.

16. The composite material according to claim 12, wherein the light scattering material is a rutile form titanium dioxide pigment with average crystal size of 220 nm.

17. The composite material according to claim 12, wherein the light scattering material is calcium carbonate.

18. The composite material according to claim 12, wherein the light scattering material is kaolin clay.

19. A process for producing a composite material comprising a continuous phase of a water-insoluble polysaccharide and particles of an inert material, wherein the process comprises mixing the water-insoluble polysaccharide with an ionic liquid solvent to dissolve said polysaccharide and thereby form a solution, said solution being substantially free of water, organic solvent or nitrogen containing base, and then mixing said dissolved polysaccharide with the particles of the light scattering material at a temperature and for a period sufficient to disperse particles substantially homogeneously therein and thereby form an ionic liquid dispersion, and subsequently separating the composite material from the ionic liquid dispersion as particles, flocs, a monolith, fibers, microspheres, or film.

20. The process according to claim 19, wherein microwave irradiation is applied to assist in dissolution of polysaccharide.

21. The process according to claim 19, wherein pressure is applied to assist in dissolution of polysaccharide.

22. The process according to claim 19, wherein the ionic liquid solvent is molten at a temperature of about −44 to about 200° C.

23. The process according to claim 19, wherein the ionic liquid solvent comprises a cation and an anion; wherein the cation of the ionic liquid solvent is selected from the group consisting of 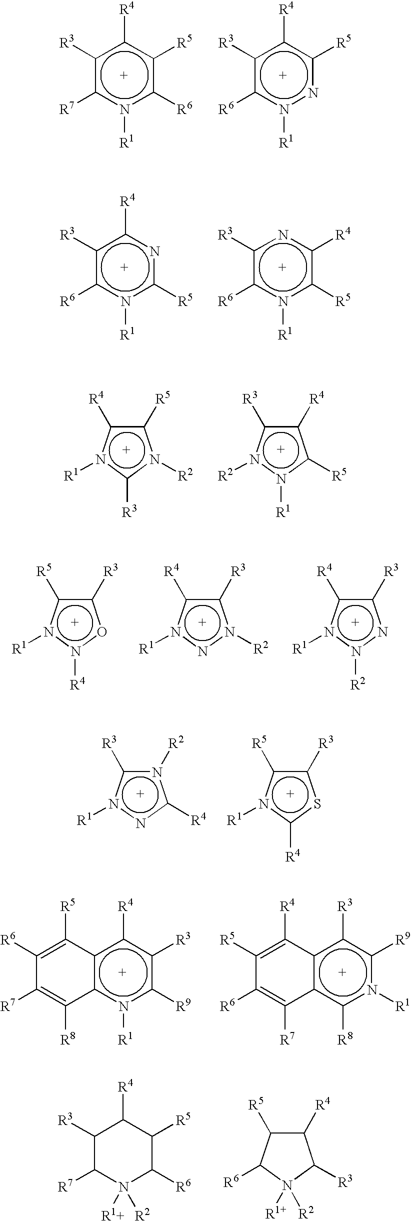
wherein R¹ and R² are independently a C₁-C₆ alkyl or C₂-C₈ alkoxyalkyl group, and R³, R⁴, R⁵, R⁶, R⁷, R⁸ and R⁹ are independently hydrogen, a C₁-C₆ alkyl, C₂-C₈ alkoxyalkyl, C₁-C₈ alkoxy group, or halogen, and
wherein the anion of the ionic liquid solvent is halogen, pseudohalogen, perchlorate or C₁-C₆ carboxylate.

24. The process according to claim 23, wherein said cation comprises 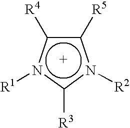
wherein R³-R⁵ are each hydrogen and R¹ and R² are the same or different and represent C₁-C₆ alkyl, and said anion is halogen, preferably chloride.

25. The process according to claim 19, wherein the polysaccharide material and the light scattering material together represent an amount of 1% to 71% by weight of the ionic liquid dispersion.

26. The process according to claim 19, wherein the inert light scattering material particles represents an amount of 0.005% to 70% by weight of the ionic liquid dispersion.

27. The process according to claim 19, wherein the composite material is precipitated from the ionic liquid dispersion by admixing said dispersion with a non-solvent for said composite material.

28. The process according to claim 27, wherein the said admixing is carried out by extruding said dispersion through a die and into said non-solvent.

29. The process according to claim 27, wherein the non-solvent is water, an alcohol, a ketone, acetonitrile, a polyglycol, an ether, or a mixture of said non-solvents.

30. The process according to claim 19, wherein the morphology of the composite material is adjusted by selection of light scattering material particle, non-solvent and temperature applied in the precipitation of said composite material.

31. The process according to claim 19, wherein the morphology of the composite material is adjusted by bubbling gas into the ionic liquid dispersion before and in connection with precipitation of said composite material.

32. The use of a composite material comprising a continuous phase of a water-insoluble polysaccharide and particles of an inert light scattering material, wherein said composite material is employed in the manufacturing of paper and board.

33. The use according to claim 32, wherein the composite material comprises 0.01-99.99% by weight of water-insoluble polysaccharide and 0.01-99.99% by weight of inert light scattering material particles.

34. The use according to claim 32, wherein the composite material comprises 3-97% by weight of water-insoluble polysaccharide and 3-97% by weight of inert light scattering material particles.

35. The use according to claim 32, wherein the composite material comprises 40-97% by weight of inert light scattering material particles.

36. The use according to claim 32, wherein that the composite material comprises 70-97% by weight of inert light scattering material particles.

37. The use according to claim 32,
wherein the composite material is produced by a process comprising
forming an ionic liquid dispersion comprising the water insoluble polysaccharide the light scattering material particles, and an ionic liquid solvent, and
precipitating the composite material from the ionic liquid dispersion; and
wherein the morphology of composite material has been adjusted by selection of light scattering material particles, non-solvent, and temperature applied in the precipitation of said composite material.

38. The use according to claim 37, wherein the morphology of composite material has been adjusted with gas.

39. The use according to claim 32, wherein the light scattering material is selected from the group consisting of titanium dioxide, kaolin clay, calcinated clay, talc, gypsum, calcium carbonate, hydrated aluminum oxide, sodium alumino silicate, calcium alumino silicate, barium sulfate, hydrated aluminum potassium silicate, diatomaceous earth, calcium oxalate and zinc oxide.

40. The use according to claim 32, wherein the light scattering material is selected from the group consisting of titanium dioxide, calcium carbonate and kaolin clay.

41. The use according to claim 39, wherein the particles of the light scattering material in the composite have an average particle size of 0.15 μm to 50 μm.

42. The use according to claim 32, wherein the water-insoluble polysaccharide is selected from the group consisting of cellulose, chitin, and mixtures thereof.

43. The use according to claim 32, wherein the composite material is used as a substantially organic filler in the manufacturing of paper.

44. The use according to claim 43, wherein the composite material comprises 70-99.99% by weight of water-insoluble polysaccharide.

45. The use according to claim 43, wherein the composite material comprises 97-99.99% by weight of water-insoluble polysaccharide.

46. The use according to claim 43, wherein the water-insoluble polysaccharide is cellulose, chitin, or a mixture thereof.

47. The use according to claim 43,
wherein the composite material is produced by a process comprising
forming an ionic liquid dispersion comprising the water insoluble polysaccharide, the light scattering material particles, and an ionic liquid solvent, and
precipitating the composite material from the ionic liquid dispersion, and
wherein the morphology of composite material has been adjusted by selection of light scattering material particle, non-solvent and temperature applied in the precipitation of said composite material.

48. The use according to claim 47, wherein the morphology of composite material has been adjusted with gas.

49. The use according to claim 32, wherein the paper or board product is produced substantially of said composite material.

50. The use of composite material comprising a continuous phase of a water-insoluble polysaccharide and particles of an inert light scattering material, wherein said composite material is employed for improving retention of light scattering material in the manufacture of paper and board.

51. The process according to claim 32, wherein the composite material is used as filler and/or pigment in the manufacturing of paper.

52. The process according to claim 32, wherein the composite material is used as filler in the manufacturing of board.

53. The process according to claim 32, wherein the composite material is used as pigment in the manufacturing of board.
